(19) United States
(12) Patent Application Publication
(10) Pub. No.: US 2017/0371615 A1
(43) Pub. Date: Dec. 28, 2017

(54) ALERTING A USER TO A CHANGE IN AN AUDIO STREAM

(71) Applicant: QUALCOMM Incorporated, San Diego, CA (US)

(72) Inventors: Bapineedu Chowdary GUMMADI, Hyderabad (IN); Binil Francis JOSEPH, Hyderabad (IN); Narukula RAJESH, Hyderabad (IN); Venkata A Naidu BABBADI, Hyderabad (IN)

(21) Appl. No.: 15/190,141

(22) Filed: Jun. 22, 2016

(51) Int. Cl. G06F 3/16; G10L 25/81; G10L 25/63; G10L 25/84; G08B 21/18

(52) U.S. Cl. CPC G06F 3/165; G10L 25/84; G08B 21/18; G10L 25/63; G10L 25/81

(57) ABSTRACT

Disclosed are methods and systems for alerting a user to a change in an audio stream. In an aspect, a user device of the user receives the audio stream, detects a change in an audio pattern occurring in the audio stream, wherein the detection of the change in the audio pattern occurs when the audio stream is muted, and in response to the detection of the change in the audio pattern, provides an alert to the user that indicates the change in the audio pattern has occurred.

### INTRODUCTION

Aspects of this disclosure relate generally to telecommunications, and more particularly to alerting a user to a change in an audio stream and the like.

Wireless communication systems are widely deployed to provide users with various types of communication content, such as voice, data, multimedia, and so on. Often, when receiving an audio stream, such as during a call to a service center, a conference call, a multicast call, etc., the attention of the user receiving the audio stream is only required at certain times, such as when the user is taken off of “hold,” when the user's name is called, during presentation of a topic of interest to the user, etc.

For example, often when a user calls a service center, the user must wait on hold until a representative takes the call. As another example, during a conference call, only a certain topic may require the user's attention and/or input. As yet another example, during a multicast call, the user may only be interested in listening to one speaker's presentation rather than each speaker's presentation. In such cases, the user must unnecessarily and inconveniently pay attention to the entire audio stream even though the user is only interested in a portion of the audio stream.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

A method of alerting a user to a change in an audio stream includes receiving, by a user device of the user, the audio stream, detecting, by the user device, a change in an audio pattern occurring in the audio stream, wherein the detection of the change in the audio pattern occurs when the audio stream is muted, and in response to the detection of the change in the audio pattern, providing, by the user device, an alert to the user that indicates the change in the audio pattern has occurred.

An apparatus for alerting a user to a change in an audio stream includes at least one processor configured to receive the audio stream, detect a change in an audio pattern occurring in the audio stream, wherein the detection of the change in the audio pattern occurs when the audio stream is muted, and provide, in response to the detection of the change in the audio pattern, an alert to the user that indicates the change in the audio pattern has occurred, a transceiver coupled to the at least one processor, and a memory coupled to the at least one processor.

An apparatus for alerting a user to a change in an audio stream includes a processing means for receiving the audio stream, detecting a change in an audio pattern occurring in the audio stream, wherein the detection of the change in the audio pattern occurs when the audio stream is muted, and providing, in response to the detection of the change in the audio pattern, an alert to the user that indicates the change in the audio pattern has occurred, a communication means coupled to the processing means, and a memory means coupled to the processing means.

A non-transitory computer-readable medium storing computer executable code including code to cause a user device of a user to receive an audio stream, cause the user device to detect a change in an audio pattern occurring in the audio stream, wherein the detection of the change in the audio pattern occurs when the audio stream is muted, and cause the user device to provide, in response to the detection of the change in the audio pattern, an alert to the user that indicates the change in the audio pattern has occurred.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of embodiments of the disclosure will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an embodiment of the disclosure.

FIG. 2 illustrates examples of user equipments (UEs) in accordance with embodiments of the disclosure.

FIG. 3 illustrates a server in accordance with an embodiment of the disclosure.

FIG. 4 illustrates an exemplary flow for alerting a user to a change in an audio stream according to at least one aspect of the disclosure.

FIG. 5 illustrates an exemplary flow showing various audio streams that can be monitored by the audio pattern detection module.

FIG. 6 illustrates an exemplary flow for alerting a user to a change in an audio stream according to at least one aspect of the disclosure.

FIG. 7 is a simplified block diagram of several sample aspects of an apparatus configured to support communication as taught herein.

### DETAILED DESCRIPTION

Disclosed are methods and systems for alerting a user to a change in an audio stream. In an aspect, a user device of the user receives the audio stream, detects a change in an audio pattern occurring in the audio stream, wherein the detection of the change in the audio pattern occurs when the audio stream is muted, and in response to the detection of the change in the audio pattern, provides an alert to the user that indicates the change in the audio pattern has occurred.

These and other aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a wired access network and/or a radio access network (RAN). As used herein, the term “UE” may be referred to interchangeably as an “access terminal” or “AT,” a “wireless device,” a “subscriber device,” a “subscriber terminal,” a “subscriber station,” a “user terminal” or “UT,” a “mobile device,” a “mobile terminal,” a “mobile station” and variations thereof. In an embodiment, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to cellular telephones, personal digital assistants (PDAs), pagers, laptop computers, desktop computers, PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

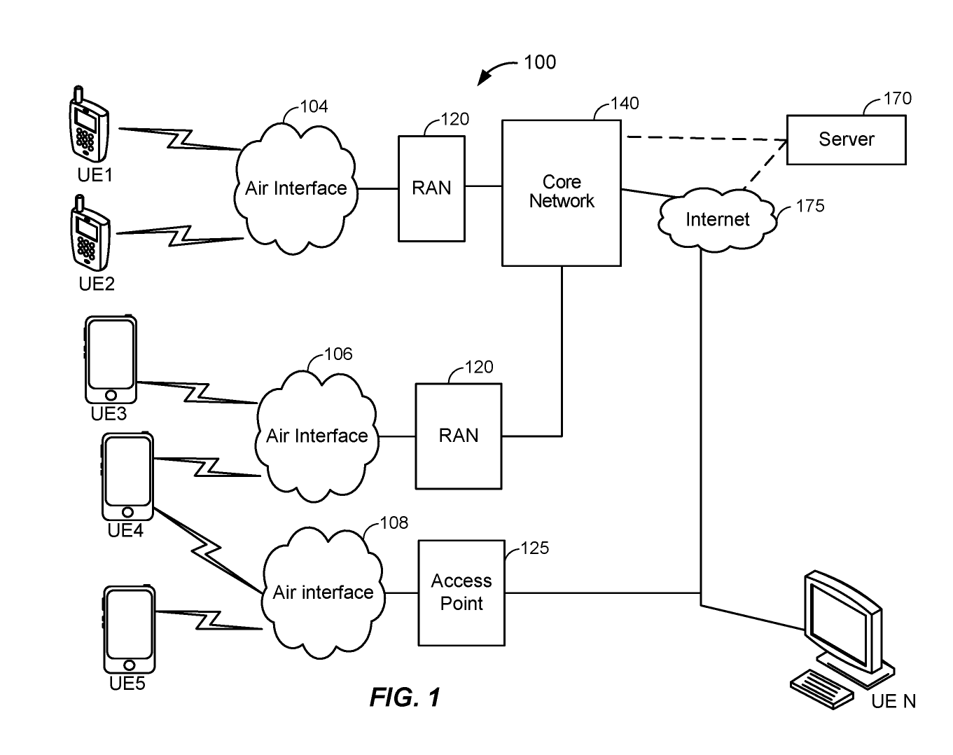

FIG. 1 illustrates a high-level system architecture of a wireless communications system 100 in accordance with an embodiment of the disclosure. The wireless communications system 100 contains UEs 1 . . . N. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., a RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., Code Division Multiple Access (CDMA), Evolution-Data Optimized (EVDO), Enhanced High Rate Packet Data (eHRPD), the Global System for Mobile access (GSM), Enhanced Data rates for Global Evolution (EDGE), Wideband CDMA (W-CDMA), Long-Term Evolution (LTE), etc.), while the air interface 108 can comply with a wireless IP protocol (e.g., IEEE 802.11). The RAN 120 may include a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 may be configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as the Internet 175.

The Internet 175, in some examples includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UEs 1 . . . N via the core network 140. Also shown in FIG. 1 is the access point 125 that is separate from the RAN 120. The access point 125 may be connected to the Internet 175 independent of the core network 140 (e.g., via an optical communications system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a server 170 is shown as connected to the Internet 175, the core network 140, or both. The server 170 can be implemented as a plurality of structurally separate servers, or alternately may correspond to a single server. As will be described below in more detail, the server 170 is configured to support one or more communication services (e.g., Voice-over-Internet Protocol (VoIP) sessions, Push-to-Talk (PTT) sessions, group communication sessions, social networking services, etc.) for UEs that can connect to the server 170 via the core network 140 and/or the Internet 175, and/or to provide content (e.g., web page downloads) to the UEs.

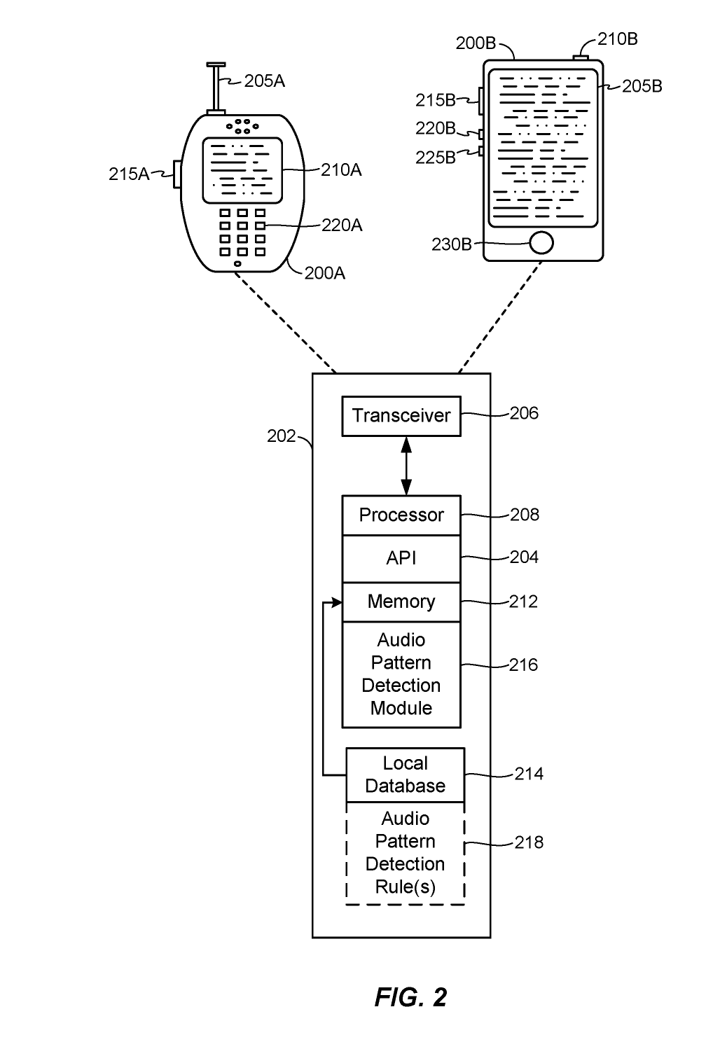

FIG. 2 illustrates examples of UEs (i.e., client devices) in accordance with embodiments of the disclosure. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), and at least one front-panel button 230B (e.g., a Home button, etc.), among other components, as is known in the art. While not shown explicitly as part of UE 200B, UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on. Additionally, while not shown explicitly, UE 200A and UE 200B include a at least one microphone and one or more speakers.

While internal components of UEs such as UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., server 170, web URLs, etc.). The platform 202 can also independently execute locally stored applications without RAN interaction. The platform 202 can include a transceiver 206 operably coupled to a processor 208, such as ASIC, or other processor, microprocessor, logic circuit, or other data processing devices. The processor 208 or other processor executes an application programming interface (API) 204 layer that interfaces with any resident programs in a memory 212 of the wireless device. The memory 212 can be comprised of read-only or random-access memory (ROM or RAM), electrically erasable programmable ROM (EEPROM), flash cards, or any memory common to computer platforms. The platform 202 also can include a local database 214 that can store applications not actively used in the memory 212, as well as other data. The local database 214 is typically a flash memory cell, but can be any secondary storage device as known in the art, such as magnetic media, EEPROM, optical media, tape, soft or hard disk, or the like.

The platform 202 further includes an audio pattern detection module 216. The audio pattern detection module 216 may be an application executed from memory 212 by processor 208. Alternatively, the audio pattern detection module 216 may be a hardware circuit or a hardware and software component (e.g., firmware) coupled to processor 208. The functionality of the audio pattern detection module 216 will be described further herein. In an embodiment, the local database 214 may include one or more audio pattern detection rules 218, as will be described further herein.

Accordingly, an embodiment of the disclosure can include a UE (e.g., UE 200A, UE 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, the processor 208, the memory 212, the API 204, the audio pattern detection module 216, and the local database 214 (optionally including the audio pattern detection rules 218) may all be used cooperatively to load, store and execute the various functions disclosed herein, and thus the logic to perform these functions may be distributed over various elements. Alternatively, the functionality could be incorporated into one discrete component, such as the audio pattern detection module 216. Therefore, the features of the UEs 200A and 200B in FIG. 2 are to be considered merely illustrative and the disclosure is not limited to the illustrated features or arrangement.

For example, where the UEs 200A and/or 200B are configured to alert a user to a change in an audio stream, the processor 208, in conjunction with the audio pattern detection module 216, may be configured to receive the audio stream, detect a change in an audio pattern occurring in the audio stream, and provide, in response to the detection of the change in the audio pattern, an alert to the user that indicates the change in the audio pattern has occurred. The processor 208 and/or the audio pattern detection module 216 may detect the change in the audio pattern occurring in the audio stream when the audio stream is muted.

The wireless communications between UEs 200A and/or 200B and the RAN 120 can be based on different technologies, such as CDMA, W-CDMA, Time Division Multiple Access (TDMA), Frequency Division Multiple Access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the disclosure and are merely to aid in the description of aspects of embodiments of the disclosure.

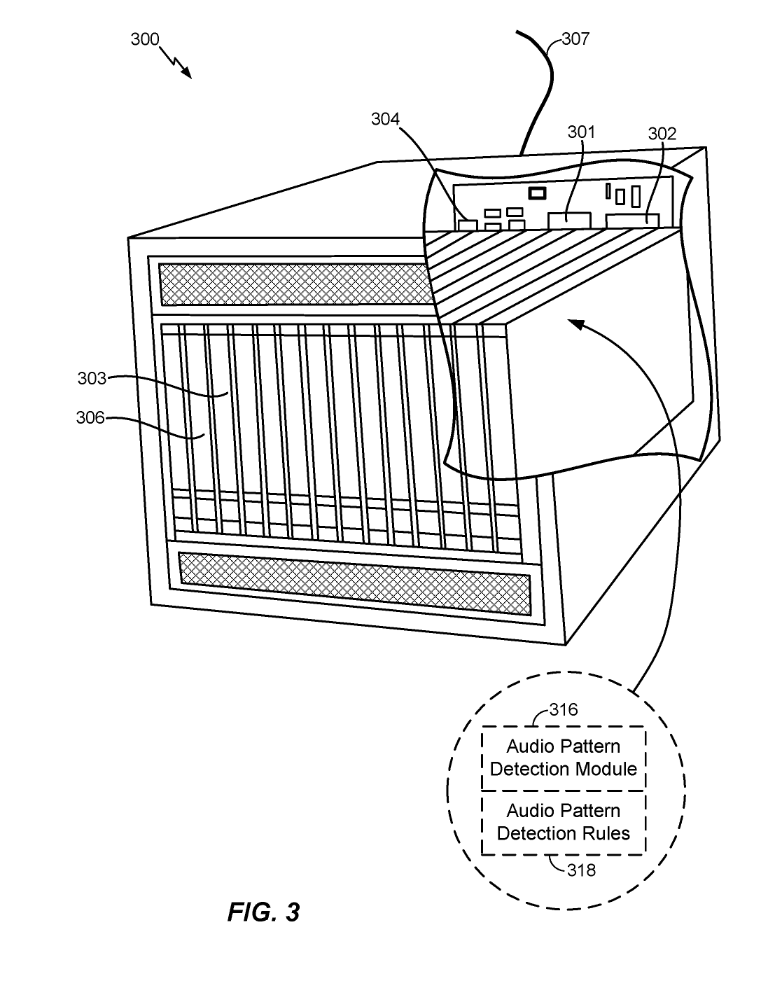

The various embodiments may be implemented on any of a variety of commercially available server devices, such as server 300 illustrated in FIG. 3. In an example, the server 300 may correspond to one example configuration of the server 170 described above. In FIG. 3, the server 300 includes a processor 301 coupled to volatile memory 302 and a large capacity nonvolatile memory, such as a disk drive 303. The server 300 may also include a floppy disc drive, compact disc (CD) or DVD disc drive 306 coupled to the processor 301. The server 300 may also include a network interface 304 (e.g., network access ports) coupled to the processor 301 for establishing data connections with a network 307, such as a local area network (LAN) coupled to other broadcast system computers and servers or to the Internet 175.

The server 300 may further include an audio pattern detection module 316. The audio pattern detection module 316 may be an application executed from volatile memory 302 by processor 301. Alternatively, the audio pattern detection module 316 may be a hardware circuit or a hardware and software component (e.g., firmware) coupled to processor 301. The functionality of the audio pattern detection module 316 will be described further herein. In an embodiment, the volatile memory 302 and/or the disk drive 303 may include one or more audio pattern detection rules 318, as will be described further herein.

As noted above, often when receiving an audio stream, such as during a call to a service center, a conference call, a multicast call, etc., the attention of the user receiving the audio stream is only required at certain times, such as when the user is taken off of “hold,” when the user's name is called, during presentation of a topic of interest to the user, etc.

For example, often when a user calls a service center, the user must wait on hold until a representative takes the call. As another example, during a conference call, only a certain topic may require the user's attention and/or input. As yet another example, during a multicast call, the user may only be interested in listening to one speaker's presentation rather than each speaker's presentation. In such cases, the user must unnecessarily and inconveniently pay attention to the entire audio stream even though the user is only interested in a portion of the audio stream.

Accordingly, the present disclosure provides methods and systems for alerting a user to a change in an audio stream being received at the user's user device (e.g., UE 200A or UE 200B). The audio stream may be any audio stream received, captured, and/or played at the UE 200A or UE 200B, such as the audio stream of an interactive voice and/or video call (e.g., a video conference call, a telephone multicast call, etc.), the audio stream of a non-interactive video stream (e.g., where the user is watching streaming video content), a non-interactive audio stream (e.g., where the user is listening to streaming audio), an audio stream captured by one or more microphones of the UE 200A or UE 200B, etc.

In an embodiment, the user can define an audio pattern detection rule 218 that defines an audio pattern that will be detected in an audio stream. The audio pattern may be, for example, a change from music to a human voice (e.g., as would occur when the user is taken off of “hold”), a change from a human voice to music, a change from non-music noise (e.g., static, background noise, etc.) to a human voice, a change from a human voice to non-music noise (e.g., static, background noise, etc.), a change in the speaker, a change to a particular speaker, a change in emotion of the speaker (e.g., the speaker begins speaking more sharply), a keyword (e.g., the user's name) or series of keywords, a change from a first music pattern to a second music pattern, a change from a first noise pattern to a second noise pattern, etc. Note that as used herein, the term “human voice” does not refer only to the voice of a human that is being conveyed in the audio stream in real time (i.e., the audio stream is being received at the UE 200A or UE 200B substantially as the speaker is speaking), but rather, may be the voice of a human that has been pre-recorded or even synthesized.

In an embodiment, the audio pattern detection module 216 may present a user interface on display 210A of UE 200A or touchscreen display 205B of UE 200B to permit the user to define audio pattern detection rules 218. The user may define one or more audio pattern detection rules 218 when accepting an incoming audio stream, when the UE 200A or UE 200B first begins receiving or playing the audio stream, any time during playback of the audio stream, while capturing the audio stream, or in advance. For example, the user may set certain rules for certain types of audio streams in advance, such as “Alert me whenever my name is spoken in a conference call,” “Alert me whenever John Smith speaks,” “Alert me when a representative takes me off of hold,” etc. Note that although these are rules that can be established in advance, the user may also set them at any time the UE 200A or UE 200B is playing the audio stream.

As another example, before beginning to play an audio stream (e.g., before accepting an incoming call or before playing a pre-recorded audio stream), the audio pattern detection module 216 may ask the user if he or she would like to select one or more previously stored audio pattern detection rules 218 or to define one or more new audio pattern detection rules 218 for the audio stream. If the user chooses to define a new audio pattern detection rule 218, the audio stream may begin playing while the user defines the new audio pattern detection rule 218, as in the case where the audio stream is a live call. Alternatively, playback of the audio stream may be paused while the user defines or selects one or more audio pattern detection rules 218, as in the case where the audio stream has been pre-recorded. Additionally, at any time while an audio stream is playing, the user can select a menu option presented by the audio pattern detection module 216 to select a different or additional audio pattern detection rule 218 to apply to the current audio stream, and/or to define a new audio pattern detection rule 218 that will apply to the current audio stream and may be saved for future audio streams. In an embodiment, the audio pattern detection rules 218 may be stored in local database 214.

After the user selects one or more audio pattern detection rules 218 to apply to an audio stream, the audio pattern detection module 216 monitors the audio stream to detect the audio pattern(s) defined by the selected audio pattern detection rule(s) 218. The audio pattern detection module 216 may use an audio pattern detection method appropriate to the type of audio pattern being detected. For example, where an audio pattern detection rule 218 defines a change from music to a human voice, a change from a human voice to music, a change from non-music noise to a human voice, a change from a human voice to non-music noise, a change from a first speaker to a second speaker, a change in emotion of the speaker, etc., the audio pattern detection module 216 may use voice characteristic analysis of the audio stream to detect such changes in the audio stream. As another example, where an audio pattern detection rule 218 defines a keyword, series of keywords, a change from music to a human voice, a change from a human voice to music, a change from non-music noise to a human voice, a change from a human voice to non-music noise, etc., the audio pattern detection module 216 may use speech-to-text conversion of the audio stream to detect such changes in the audio stream. As yet another example, where an audio pattern detection rule 218 defines a change from a first music pattern to a second music pattern, a change from a first noise pattern to a second noise pattern, etc., the audio pattern detection module 216 may use spectral analysis of the audio stream to detect such changes in the audio stream.

As will be appreciated, the audio pattern detection methods discussed above do not require the audio stream to be output by the speakers of the UE 200A or UE 200B. As such, the audio stream may be muted while the audio pattern detection module 216 monitors the audio stream. This provides an additional convenience for the user, insofar as the user will not be distracted by portions of the audio stream that are not of interest to the user, and the user may instead listen to other audio material if he or she wishes.

When the audio pattern detection module 216 detects an audio pattern in the audio stream matching an audio pattern detection rule 218, it causes the UE 200A or UE 200B to provide an alert to the user. The alert may be user configurable. In an embodiment, the alert may be a vibration of the UE 200A or UE 200B, a light illuminating on the UE 200A or UE 200B, a popup window displayed on the display 210A of UE 200A or the touchscreen display 205B of UE 200B, or an audible tone played by the UE 200A or UE 200B. In another embodiment, the audio pattern detection module 216 may cause the UE 200A or UE 200B, specifically transceiver 206, to send the alert to a second user device belonging to the user, and the second user device may provide the alert to the user. Alternatively, both the UE 200A or UE 200B and the second user device may alert the user. In yet another alternative, the audio pattern detection module 216 may cause the UE 200A or UE 200B, specifically transceiver 206, to broadcast the alert to each user device belonging to the user that is capable of providing alerts, and each user device of the user may alert the user of the change in the audio pattern.

In an embodiment, rather than monitor an audio stream locally at the UE 200A or UE 200B, the audio pattern detection module 216 may cause the UE 200A or UE 200B, specifically transceiver 206, to send the applicable audio pattern detection rule(s) 218 to the server from which the audio stream is being received, such as server 300. The server 300 stores the received audio pattern detection rule(s) 218 as audio pattern detection rule(s) 318 in, for example, volatile memory 302 or disk drive 303. The audio pattern detection module 216 may send all of the audio pattern detection rule(s) 218 stored in local database 214, or only the audio pattern detection rule(s) 218 selected for the audio stream currently being received from the server 300. For example, upon receiving an audio stream from server 300, the user may select one or more audio pattern detection rules 218 to apply to the incoming audio stream, and the audio pattern detection module 216 may send only the selected audio pattern detection rule(s) 218 to the server 300 to be stored as audio pattern detection rule(s) 318. Alternatively, to save space in the local database 214, the audio pattern detection module 216 may send all audio pattern detection rule(s) 218 to the server 300 as they are defined rather than store them in the local database 214.

As the server 300 streams the audio stream to the UE 200A or UE 200B via network interface 304, the audio pattern detection module 316 monitors the audio stream for audio patterns matching the audio patterns defined by the audio pattern detection rule(s) 318. When the audio pattern detection module 316 detects an audio pattern in the audio stream matching an audio pattern detection rule 318 for that audio stream, it sends a notification to the UE 200A or UE 200B to provide an alert to the user. In an embodiment, the server 300 may also send notifications to other devices belonging to the user so that these devices can also alert the user, as described above. Alternatively, upon receiving the notification from the server 300, the UE 200A or UE 200B can send notifications to the other devices belonging to the user, as described above.

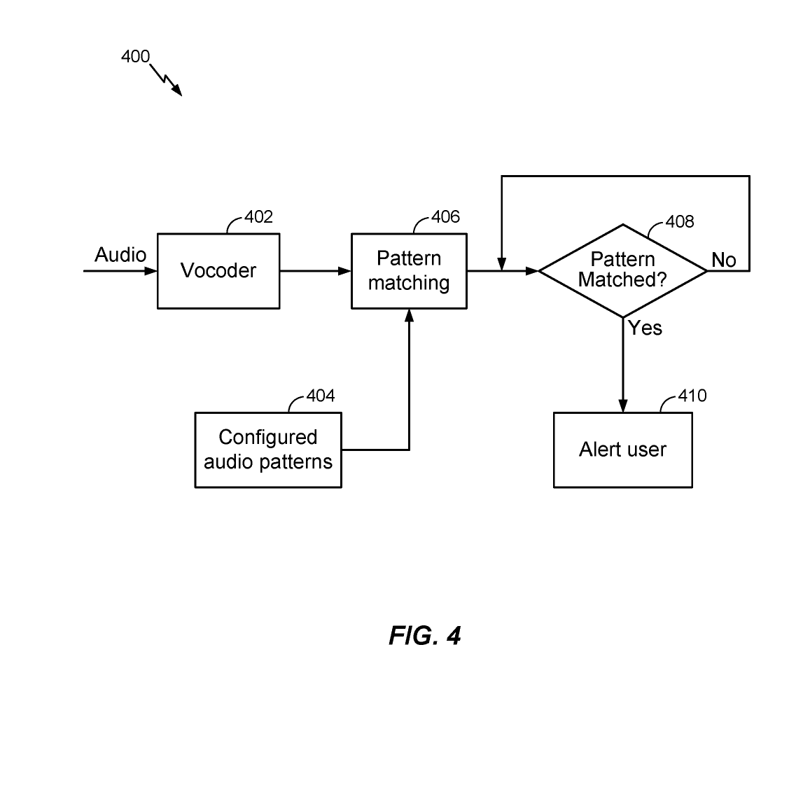

FIG. 4 illustrates an exemplary flow 400 for alerting a user to a change in an audio stream according to at least one aspect of the disclosure. The flow 400 illustrated in FIG. 4 may be performed by the audio pattern detection module 216 of UE 200A or UE 200B or the audio pattern detection module 316 of server 300. At 402, the audio pattern detection module 216 or 316 analyzes the incoming audio stream using an associated vocoder. For example, the vocoder may perform spectral analysis on the audio stream, speech-to-text conversion of the audio stream, voice characteristic analysis of the audio stream, etc. At 404, the audio pattern detection module 216 or 316 loads configured audio patterns, such as audio pattern detection rules 218 or 318, for the particular audio stream from, for example, local database 214 or from volatile memory 302 or disk drive 303.

At 406, the audio pattern detection module 216 or 316 performs pattern matching on the audio stream to detect patterns in the audio stream, such as changes from music to voice, voice to music, changes in speaker, keywords, changes in speaker emotion, changes in music patterns, changes in noise patterns, etc. At 408, the audio pattern detection module 216 or 316 determines whether or not a detected audio pattern in the audio stream matches an audio pattern defined by audio pattern detection rules 218 or 318. If there is a match, then at 410, the audio pattern detection module 216 or 316 causes the UE 200A or UE 200B or the server 300 to alert the user, as described above. If there is not a match, the audio pattern detection module 216 or 316 continues to monitor the audio stream.

In an embodiment, the user may additionally or alternatively define audio pattern detection rules 218 to be applied to audio input to the UE 200A or UE 200B from sources other than an audio stream being received or played at the UE 200A or UE 200B. In an aspect, the user may define one or more audio pattern detection rules 218 to be applied to the voice of the user of UE 200A or UE 200B while the user is speaking into the microphone of the UE 200A or UE 200B, such as when the user is on a call. For example, the user may wish to be notified when he or she utters a particular word or set of words, or may wish for the UE 200A or UE 200B to begin recording or to cease recording the call.

In another aspect, the user may define one or more audio pattern detection rules 218 to be applied to environmental sound(s) captured by the UE 200A or UE 200B. That is, the user may define one or more audio pattern detection rules 218 to be applied to audio captured by the microphone of the UE 200A or UE 200B other than the voice of the user. For example, when the user is listening to audio through headphones connected to the UE 200A or UE 200B (e.g., via a wire, Bluetooth®, etc.) and is therefore unable to clearly hear environmental sounds, the user may wish to be notified when someone is calling his or her name. The audio being played through the headphones may automatically be paused or muted while the notification is played or otherwise provided for the user.

Note that the user need not be listening to audio to be notified. Rather, the user can define an audio pattern detection rule 218 to notify the user of a detected environmental sound (e.g., the user's name, a pattern of words, the presence of a human voice, a particular music pattern, etc.) when the user is performing any task with the UE 200A or UE 200B in an active state, such as reading a book, writing an email, browsing a website, etc. This can be useful when the user is concentrating on such a task and isn't paying attention to external sounds.

In an aspect, the user can be informed of emergency notifications in the surrounding environment, regardless of whether the user has defined an audio pattern detection rule 218 to notify the user of such emergencies/audio patterns. For example, the UE 200A or UE 200B may notify the user when fire alarms, explosions, sirens, and the like are detected in the surrounding environment, regardless of whether the user has defined a corresponding audio pattern detection rule 218. Instead, such an audio pattern detection rule 218 may be populated in the local database 214 by default.

Embodiments of the disclosure can be extended to vehicles, where one or more microphones placed outside of the vehicle will detect environmental sounds around the vehicle. The user, or the vehicle manufacturer or a third party, may define one or more audio pattern detection rules 218 to be applied to the environmental sounds captured by the microphone(s). The vehicle can notify the driver when the audio pattern detection module 216 identifies a configured pattern in the audio stream detected by the microphone(s), such as a honking horn, sirens, screeching tires, etc.

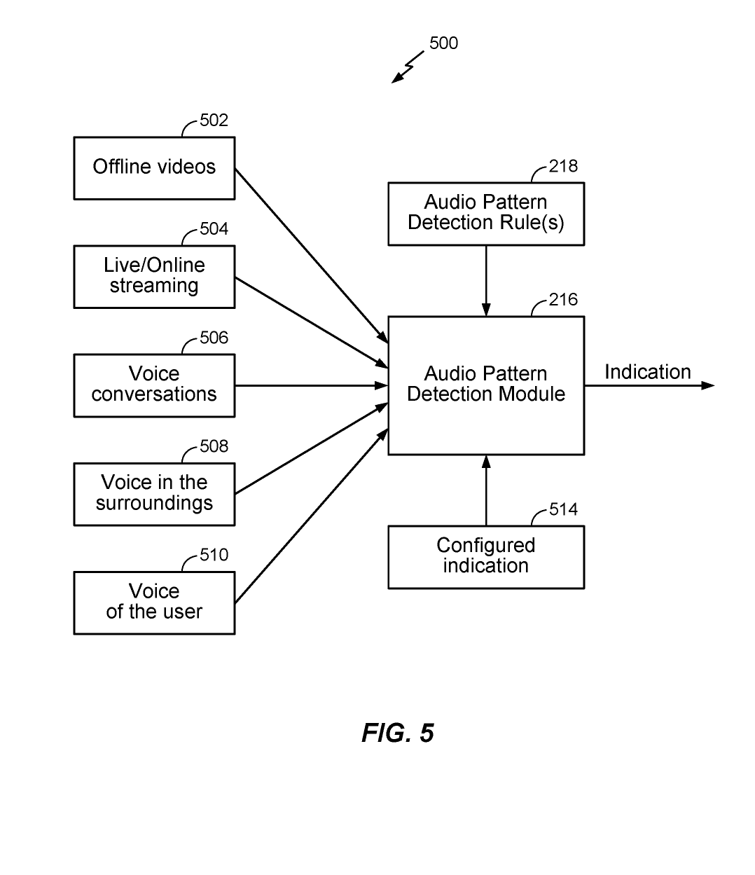

FIG. 5 illustrates an exemplary flow 500 showing various audio streams that can be monitored by the audio pattern detection module 216. The audio streams include audio from offline videos 502 (e.g., videos downloaded to and played back by the UE 200A or UE 200B), live/online streaming audio 504 (e.g., video streaming), voice conversations 506 (e.g., voice calls, video calls), voices in the environmental surroundings 508 of the UE 200A or UE 200B, and the user's own voice 510. The audio pattern detection module 216 detects audio patterns in these various sources based on audio pattern detection rules 218 and issues a configured (user or otherwise) indication 514 when a defined audio pattern is detected.

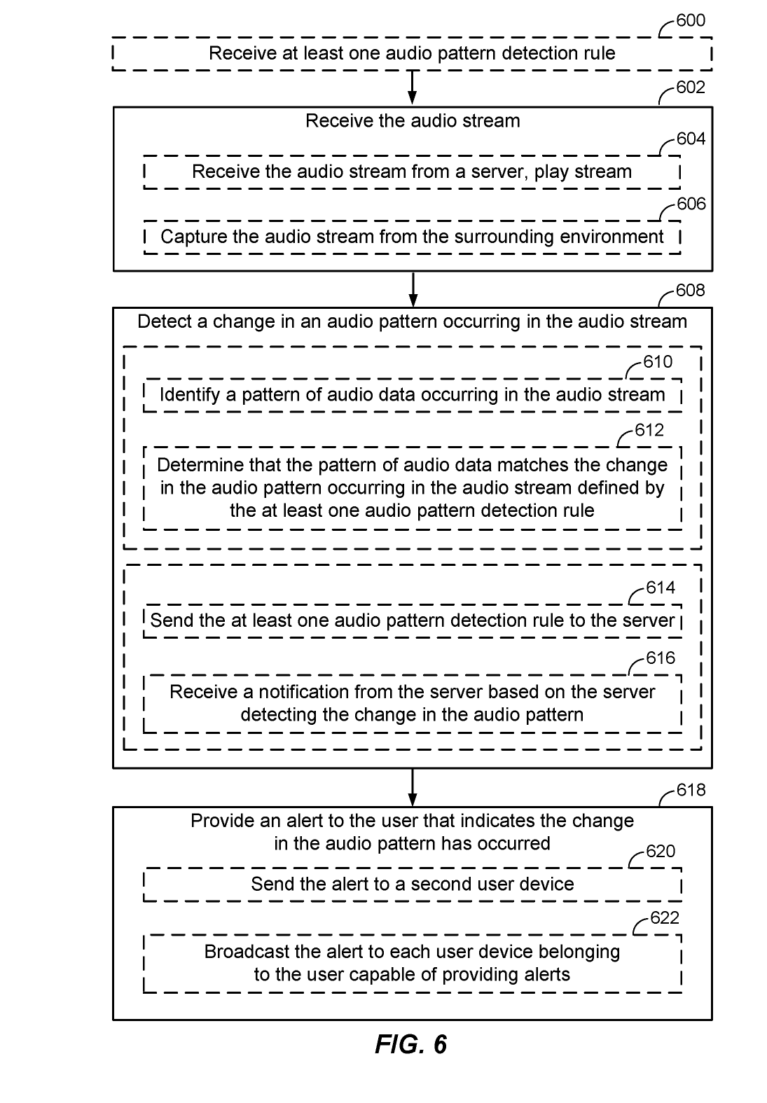

FIG. 6 illustrates an exemplary flow 600 for alerting a user to a change in an audio stream according to at least one aspect of the disclosure. The flow illustrated in FIG. 6 may be performed by a user device, such as the UE 200A or UE 200B in FIG. 2.

At 600, the user device (e.g., audio pattern detection module 216) optionally receives at least one audio pattern detection rule (e.g., an audio pattern detection rule 218). The user device may receive the at least one audio pattern detection rule based on user input via the user interface of the user device (e.g., keypad 220A and/or touchscreen display 205B). Operation 604 is optional because the at least one audio pattern detection rule may be a default rule, prepopulated by the audio pattern detection module 216, etc.

At 602, the user device receives the audio stream. At 604, the user device (e.g., transceiver 206) optionally receives the audio stream from a server, such as server 300. The user device may receive the audio stream substantially in real-time as it is generated, such as where the audio stream is a phone call. Alternatively, the audio stream may correspond to a media file that was previously stored in the memory of the user device (e.g., local database 214), either based on a previous network download, reception from a peer device, etc.

Where the user device receives the audio stream from a server, peer device, or local memory, the user device (e.g., processor 208 in conjunction with audio pattern detection module 216) plays the audio stream. Where the audio stream is received from the server (e.g., server 300) or peer device, the user device may play the audio stream substantially in real-time as the audio stream is received. The audio stream may be muted while it is being played based on input from the user muting the audio stream.

Alternatively, at 606, the user device (e.g., one or more microphones of the user device) optionally captures the audio stream from the surrounding environment. The user device may capture the audio stream while the user is listening to a different audio stream being played through wired or wireless headphones coupled to the user device. However, the user need not be listening to another audio stream, nor is it necessary that the user device be coupled to a set of headphones. Rather, the audio pattern detection module 216 may analyze the captured audio stream based on an instruction from the user.

At 608, the user device (e.g., processor 208 in conjunction with audio pattern detection module 216) detects a change in an audio pattern occurring in the audio stream. As described herein, the detection of the change in the audio pattern may occur when the audio stream is muted. Where the user device is capturing the audio stream, the audio stream being muted means, for example, that the user device is not playing the captured audio stream.

In an aspect, detecting the change in the audio pattern at 608 may include identifying, at 610, a pattern of audio data occurring in the audio stream and determining, at 612, that the pattern of audio data matches the change in the audio pattern occurring in the audio stream defined by the at least one audio pattern detection rule. In an alternative aspect, detecting the change in the audio pattern at 608 may include the user device (e.g., transceiver 206) sending, at 614, the at least one audio pattern detection rule to the server (e.g., server 300), wherein the server (e.g., processor 301 in conjunction with audio pattern detection module 316) detects the change in the audio pattern based on the at least one audio pattern detection rule (e.g., stored as audio pattern detection rule 318). In that case, the flow further includes the user device (e.g., transceiver 206) receiving, at 616, a notification from the server based on the server detecting the change in the audio pattern.

At 618, in response to the detection of the change in the audio pattern, the user device (e.g., display 210A, touchscreen display 205B, etc.) provides an alert to the user that indicates the change in the audio pattern has occurred. In an aspect, providing the alert may additionally include the user device (e.g., transceiver 206) sending, at 620, the alert to a second user device, wherein the second user device provides the alert to the user. In another aspect, providing the alert may additionally or alternatively include the user device (e.g., transceiver 206) broadcasting, at 622, the alert to each user device belonging to the user capable of providing alerts, wherein each user device of the user notifies the user of the change in the audio pattern.

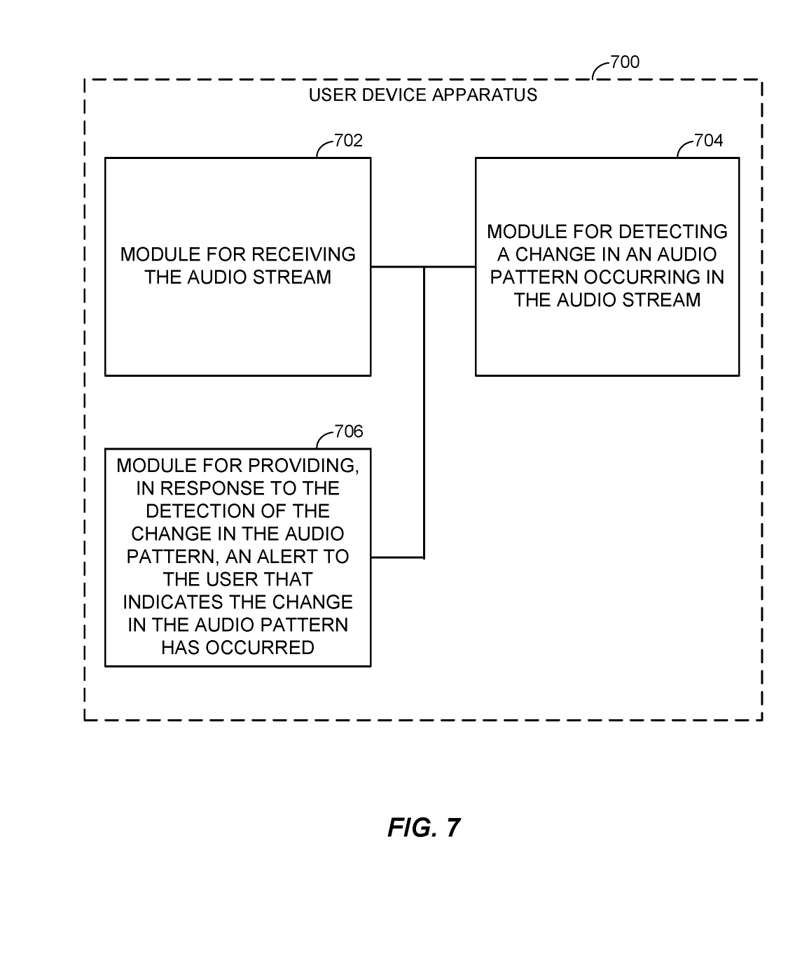

FIG. 7 illustrates an example user device apparatus 700 represented as a series of interrelated functional modules. A module for receiving 702 may correspond at least in some aspects to, for example, a processing system, such as processor 208 optionally in conjunction with the audio pattern detection module 216 in FIG. 2, as discussed herein. The audio pattern detection module 216 is optional here because it may not be required in order to play the audio stream. A module for detecting 704 may correspond at least in some aspects to, for example, a processing system, such as processor 208 in conjunction with audio pattern detection module 216 in FIG. 2, optionally in conjunction with a communication device, such as transceiver 206, as discussed herein. A module for providing 706 may correspond at least in some aspects to, for example, a processing system, such as processor 208 in conjunction with audio pattern detection module 216 in FIG. 2, optionally in conjunction with a communication device, such as transceiver 206, as discussed herein.

The functionality of the modules of FIG. 7 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 7, as well as other components and functions described herein, may be implemented using any suitable means. Such means also may be implemented, at least in part, using corresponding structure as taught herein. For example, the components described above in conjunction with the “module for” components of FIG. 7 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

1. A method of alerting a user to a change in an audio stream, comprising:
receiving, by a user device of the user, the audio stream;
detecting, by the user device, a change in an audio pattern occurring in the audio stream, wherein the detecting the change in the audio pattern occurs when the audio stream is muted; and
in response to the detecting the change in the audio pattern, providing, by the user device, an alert to the user that indicates the change in the audio pattern has occurred.

2. The method of claim 1, further comprising:
receiving, at the user device, at least one audio pattern detection rule, wherein the at least one audio pattern detection rule defines the change in the audio pattern occurring in the audio stream.

3. The method of claim 2, wherein the detecting comprises:
identifying a pattern of audio data occurring in the audio stream;
determining that the pattern of audio data matches the change in the audio pattern occurring in the audio stream defined by the at least one audio pattern detection rule.

4. The method of claim 2, wherein the at least one audio pattern detection rule is defined based on input received at the user device from the user.

5. The method of claim 1, further comprising playing the audio stream, wherein the change in the audio pattern occurring in the audio stream comprises:
one or more pre-defined keywords spoken in the audio stream;
a change from a first speaker to a second speaker occurring in the audio stream;
a change in emotion of a speaker occurring in the audio stream;
a change from a first music pattern to a second music pattern occurring in the audio stream;
a change from a first noise pattern to a second noise pattern occurring in the audio stream;
a change from spoken words to music occurring in the audio stream;
a change from music to spoken words occurring in the audio stream;
a change from spoken words to non-music noise occurring in the audio stream; or
a change from non-music noise to spoken words occurring in the audio stream.

6. The method of claim 5, wherein the audio stream comprises an audio stream of a video stream, and wherein the one or more pre-defined keywords comprise a user-selected sequence of dialogue in the video stream.

7. The method of claim 5, wherein the one or more pre-defined keywords correspond to a pattern of spoken words in the audio stream, and wherein the pattern of spoken words is detected based on speech-to-text conversion of the audio stream.

8. The method of claim 5, wherein the change from the first speaker to the second speaker or the change in emotion of the speaker is detected based on voice characteristic analysis of the audio stream.

9. The method of claim 5, wherein the change from the first music pattern to the second music pattern is detected based on spectral analysis of the audio stream.

10. The method of claim 5, wherein the change from spoken words to music or the change from music to spoken words is detected based on voice characteristic analysis of the audio stream.

11. The method of claim 5, wherein the change from spoken words to music or the change from music to spoken words is detected based on speech-to-text conversion of the audio stream.

12. The method of claim 5, wherein a music pattern of the music occurring after the change from spoken words to music is specified by the user.

13. The method of claim 1, wherein receiving the audio stream comprises capturing, by at least one microphone of the user device, the audio stream, and wherein the change in the audio pattern occurring in the audio stream comprises:
one or more pre-defined keywords spoken by the user of the user device; or
one or more pre-defined audio events occurring in an environment of the user device.

14. The method of claim 13, wherein the audio stream is captured while the user device is coupled to a set of headphones.

15. The method of claim 13, wherein the one or more pre-defined audio events comprise one or more of a siren, an emergency alarm, an explosion, or any combination thereof.

16. The method of claim 1, further comprising receiving, at the user device, the audio stream from a server, wherein the detecting the change in the audio pattern comprises:
sending, by the user device, at least one audio pattern detection rule to the server, wherein the server detects the change in the audio pattern based on the at least one audio pattern detection rule, and
wherein the method further comprises:
receiving, at the user device, a notification from the server based on the server detecting the change in the audio pattern, wherein the alert is provided based on the notification.

17. The method of claim 1, wherein the alert comprises a vibration of the user device, a light illuminating on the user device, a popup window displayed on a user interface of the user device, or an audible tone played by the user device.

18. The method of claim 1, wherein providing the alert comprises sending the alert to a second user device, wherein the second user device provides the alert to the user.

19. The method of claim 18, wherein both the user device and the second user device provide the alert to the user.

20. The method of claim 1, wherein providing the alert comprises broadcasting the alert to each user device belonging to the user and capable of providing alerts, wherein each user device belonging to the user and capable of providing alerts notifies the user of the change in the audio pattern.

21. An apparatus for alerting a user to a change in an audio stream, comprising:
at least one processor configured to:
receive the audio stream;
detect a change in an audio pattern occurring in the audio stream, wherein detection of the change in the audio pattern occurs when the audio stream is muted; and
provide, in response to detection of the change in the audio pattern, an alert to the user that indicates the change in the audio pattern has occurred;
a transceiver coupled to the at least one processor; and
a memory coupled to the at least one processor.

22. The apparatus of claim 21, wherein the memory is configured to store at least one audio pattern detection rule, wherein the at least one audio pattern detection rule defines the change in the audio pattern occurring in the audio stream.

23. The apparatus of claim 22, wherein the at least one processor is further configured to:
identify a pattern of audio data occurring in the audio stream;
determine that the pattern of audio data matches the change in the audio pattern occurring in the audio stream defined by the at least one audio pattern detection rule.

24. The apparatus of claim 22, wherein the at least one audio pattern detection rule is defined based on input received at the apparatus from the user.

25. The apparatus of claim 21, wherein the at least one processor is further configured to play the audio stream, and wherein the change in the audio pattern occurring in the audio stream comprises:
one or more pre-defined keywords spoken in the audio stream;
a change from a first speaker to a second speaker occurring in the audio stream;
a change in emotion of a speaker occurring in the audio stream;
a change from a first music pattern to a second music pattern occurring in the audio stream;
a change from a first noise pattern to a second noise pattern occurring in the audio stream;
a change from spoken words to music occurring in the audio stream;
a change from music to spoken words occurring in the audio stream;
a change from spoken words to non-music noise occurring in the audio stream; or
a change from non-music noise to spoken words occurring in the audio stream.

26. The apparatus of claim 21, further comprising at least one microphone configured to capture the audio stream, wherein the change in the audio pattern occurring in the audio stream comprises:
one or more pre-defined keywords spoken by the user; or
one or more pre-defined audio events occurring in an environment of the apparatus.

27. The apparatus of claim 21, wherein the transceiver is configured to receive the audio stream from a server, and wherein the at least one processor is further configured to cause the transceiver to:
send at least one audio pattern detection rule to the server, wherein the server detects the change in the audio pattern based on the at least one audio pattern detection rule; and
receive a notification from the server based on detection by the server of the change in the audio pattern, wherein the alert is provided based on the notification.

28. The apparatus of claim 21, wherein the at least one processor is further configured to cause the transceiver to send the alert to a second user device, wherein the second user device provides the alert to the user.

29. An apparatus for alerting a user to a change in an audio stream, comprising:
a processing means for:
receiving the audio stream;
detecting a change in an audio pattern occurring in the audio stream, wherein detection of the change in the audio pattern occurs when the audio stream is muted; and
providing, in response to detection of the change in the audio pattern, an alert to the user that indicates the change in the audio pattern has occurred;
a communication means coupled to the processing means; and
a memory means coupled to the processing means.

30. A non-transitory computer-readable medium storing computer executable code, comprising code to:
cause a user device of a user to receive an audio stream;
cause the user device to detect a change in an audio pattern occurring in the audio stream, wherein detection of the change in the audio pattern occurs when the audio stream is muted; and
cause the user device to provide, in response to detection of the change in the audio pattern, an alert to the user that indicates the change in the audio pattern has occurred.
